(19) United States
(12) Patent Application Publication
(10) Pub. No.: US 2013/0007793 A1
(43) Pub. Date: Jan. 3, 2013

(54) PRIMARY SCREEN VIEW CONTROL THROUGH KINETIC UI FRAMEWORK

(75) Inventors: Shemimon Manalikudy Anthru, Dayton, NJ (US); Jens Cahnbley, Princeton Junction, NJ (US); David Anthony Campana, Princeton, NJ (US); David Brian Anderson, Hamilton, NJ (US); Ishan Mandrekar, Monmouth Junction, NJ (US)

(73) Assignee: Thomas Licensing

(21) Appl. No.: 13/635,056

(22) PCT Filed: Apr. 29, 2011
(86) PCT No.: PCT/US11/00753

§ 371 Date: Sep. 14, 2012

Related U.S. Application Data
(60) Provisional application No. 61/343,546, filed on Apr. 30, 2010.

(51) Int. Cl. H04N 21/258

(52) U.S. Cl. 725/14

(57) ABSTRACT

A method and system for generating a dynamic user interface on a second screen control device for controlling the content being displayed on primary viewing screen. The method and system utilizes view context which is based on the content being displayed, additional information, and the type of second screen control device. The view context is then used to generate the user interface on the second screen control device.

### CROSS REFERENCE TO RELATED APPLICATIONS

This application claims the benefit of U.S. Provisional Application Ser. No. 61/343,546 filed Apr. 30, 2010, which is incorporated by reference herein in its entirety.

### TECHNICAL FIELD

The present invention deals user interfaces and more particularly providing a dynamic user interface on a second screen control device to control media content on a primary display screen.

### BACKGROUND

The recent progress on internet based distribution and consumption of media content have caused abundance in the media content availability. This is only going to increase in the future. This explosion of content production and distribution has created interesting issues for the end user in the selection of content. The conventional set top boxes or home gateways are also evolving to enable consumption of media content through media pipes and data pipes coming to the home. This will enable the user to consume media from multiple sources regardless of the distribution channel behind the scene. In this situation, a conventional remote control or any other existing static navigation or control device prove insufficient for navigating these choices.

In addition to set top boxes and home gateways, the remotes for these systems are also evolving. There are several types of remote control devices available to control the entertainment systems at home. Some of them have a touch screen in addition to the normal hard buttons which display a small scale mapping of television screen and control panel. Other types include gesture based remote controls which depend on camera based gesture detection schemes. Still others are second screen devices, such as tablets or smart phones, running remote control software. But none of these devices incorporate a complete dynamic UI based control. A remote control which does not have access to the program-meta information or the context of currently watching program cannot adapt its interface dynamically according to the context. In other words almost all of the available remote controls are static in nature as far as its interface is concerned.

### SUMMARY

This disclosure provides a solution to this problem by introducing an adaptable user interface system to allow a second screen control device to control content on a primary display screen.

In accordance with one embodiment, a method is provided for creating a dynamic user interface on a second screen control device to control content on a primary display screen. The method includes the steps of monitoring the content being displayed on the primary display screen; obtaining additional information about content being displayed on primary screen; generating a view context based on the content being monitored, additional information, and functionality of the touch screen control device; and providing the view context to the second screen control device.

In accordance with another embodiment, a system is provided for controlling content on a primary display screen using a dynamically created user interface on a second screen control device. The system includes a client and a server. The client includes a first display control and an event listener. The first display control is configured to control a display of the second screen control device. The event listener is configured to receive commands from a user on the second screen control device. The server is in communication with the client and includes a view context creator and an event interpreter. The view context creator is configured to generate a view context based on the content being displayed on the primary display screen, additional information, and functionality of the second screen control device. The event interpreter is configured to receive the commands from the user provided by the event listener and interpret the commands in view of the view context generated by the view context creator.

### BRIEF DESCRIPTION OF THE DRAWINGS

The present principles may be better understood in accordance with the following exemplary figures, in which:

FIG. 1 is a system diagram outlining the delivery of video and audio content to the home in accordance with one embodiment.

FIG. 2 is system diagram showing further detail of a representative set top box receiver.

FIG. 3 is a diagram depicting a touch panel control device in accordance with one embodiment.

FIG. 4 is a diagram depicting some exemplary user interactions for use with a touch panel control device in accordance with one embodiment.

FIG. 5 is a system diagram depicting exemplary components of a system in accordance with one embodiment.

FIG. 6 is a flow diagram depicting an exemplary process for handling events in accordance with one embodiment.

FIG. 7 is another flow diagram depicting an exemplary process of the overall system in accordance with one embodiment.

FIG. 8 is another flow diagram depicting an exemplary process of the overall system in relation to the component of a system in accordance with one embodiment.

### DETAILED DESCRIPTION

The present principles are directed to user interfaces and more particularly a software system which provide dynamic user interface for the navigation and control of the media content.

It will thus be appreciated that those skilled in the art will be able to devise various arrangements that, although not explicitly described or shown herein, embody the present invention and are included within its spirit and scope.

All examples and conditional language recited herein are intended for pedagogical purposes to aid the reader in understanding the present invention and the concepts contributed by the inventor(s) to furthering the art, and are to be construed as being without limitation to such specifically recited examples and conditions.

Moreover, all statements herein reciting principles, aspects, and embodiments of the present invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present invention as defined by such claims resides in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

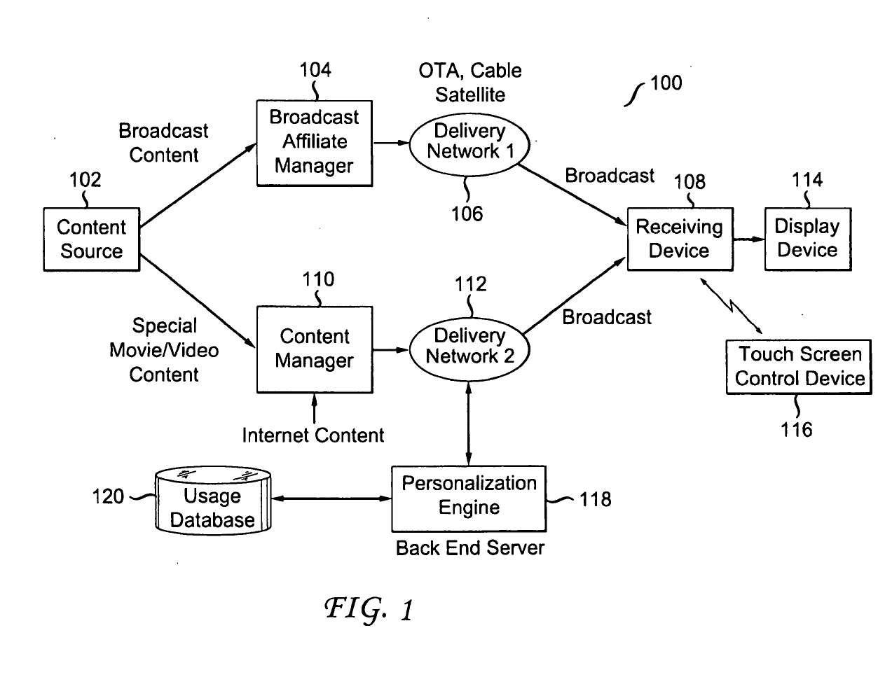

Turning now to FIG. 1, a block diagram of an embodiment of a system 100 for delivering content to a home or end user is shown. The content originates from a content source 102, such as a movie studio or production house. The content may be supplied in at least one of two forms. One form may be a broadcast form of content. The broadcast content is provided to the broadcast affiliate manager 104, which is typically a national broadcast service, such as the American Broadcasting Company (ABC), National Broadcasting Company (NBC), Columbia Broadcasting System (CBS), etc. The broadcast affiliate manager may collect and store the content, and may schedule delivery of the content over a deliver network, shown as delivery network 1 (106). Delivery network 1 (106) may include satellite link transmission from a national center to one or more regional or local centers. Delivery network 1 (106) may also include local content delivery using local delivery systems such as over the air broadcast, satellite broadcast, or cable broadcast. The locally delivered content is provided to a receiving device 108 in a user's home, where the content will subsequently be searched by the user. It is to be appreciated that the receiving device 108 can take many forms and may be embodied as a set top box/digital video recorder (DVR), a gateway, a modem, etc. Further, the receiving device 108 may act as entry point, or gateway, for a home network system that includes additional devices configured as either client or peer devices in the home network.

A second form of content is referred to as special content. Special content may include content delivered as premium viewing, pay-per-view, or other content otherwise not provided to the broadcast affiliate manager, e.g., movies, video games or other video elements. In many cases, the special content may be content requested by the user. The special content may be delivered to a content manager 110. The content manager 110 may be a service provider, such as an Internet website, affiliated, for instance, with a content provider, broadcast service, or delivery network service. The content manager 110 may also incorporate Internet content into the delivery system. The content manager 110 may deliver the content to the user's receiving device 108 over a separate delivery network, delivery network 2 (112). Delivery network 2 (112) may include high-speed broadband Internet type communications systems. It is important to note that the content from the broadcast affiliate manager 104 may also be delivered using all or parts of delivery network 2 (112) and content from the content manager 110 may be delivered using all or parts of delivery network 1 (106). In addition, the user may also obtain content directly from the Internet via delivery network 2 (112) without necessarily having the content managed by the content manager 110.

Several adaptations for utilizing the separately delivered content may be possible. In one possible approach, the special content is provided as an augmentation to the broadcast content, providing alternative displays, purchase and merchandising options, enhancement material, etc. In another embodiment, the special content may completely replace some programming content provided as broadcast content. Finally, the special content may be completely separate from the broadcast content, and may simply be a media alternative that the user may choose to utilize. For instance, the special content may be a library of movies that are not yet available as broadcast content.

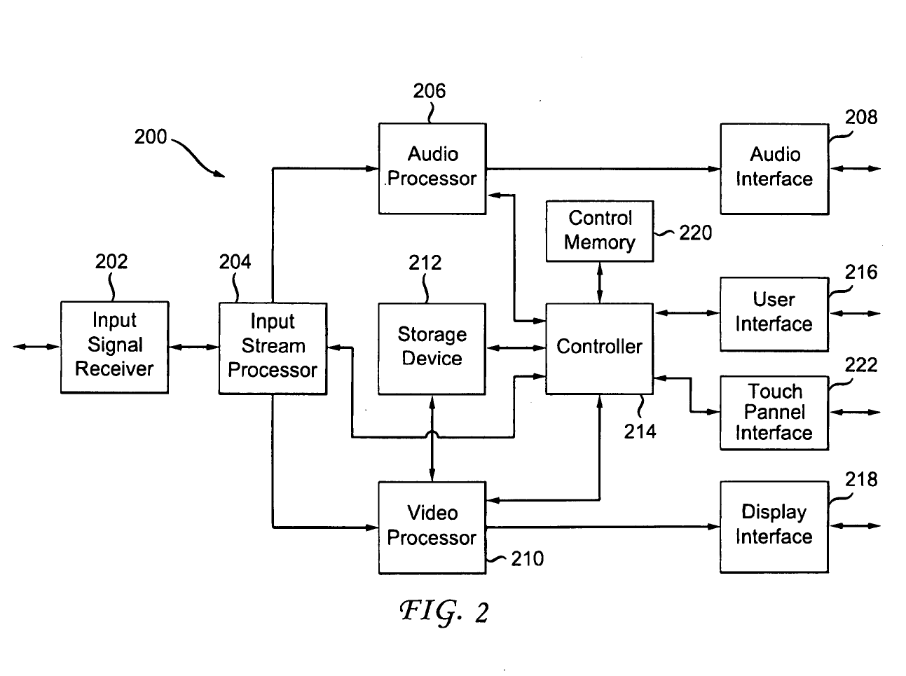

The receiving device 108 may receive different types of content from one or both of delivery network 1 and delivery network 2. The receiving device 108 processes the content, and provides a separation of the content based on user preferences and commands. The receiving device 108 may also include a storage device, such as a hard drive or optical disk drive, for recording and playing back audio and video content. Further details of the operation of the receiving device 108 and features associated with playing back stored content will be described below in relation to FIG. 2. The processed content is provided to a primary display device 114. The primary display device 114 may be a conventional 2-D type display or may alternatively be an advanced 3-D display.

The receiving device 108 may also be interfaced to a second screen such as a second screen control device such as a touch screen control device 116. The second screen control device 116 may be adapted to provide user control for the receiving device 108 and/or the display device 114. The second screen device 116 may also be capable of displaying video content. The video content may be graphics entries, such as user interface entries, or may be a portion of the video content that is delivered to the display device 114. The second screen control device 116 may interface to receiving device 108 using any well known signal transmission system, such as infra-red (IR) or radio frequency (RF) communications and may include standard protocols such as infra-red data association (IRDA) standard, Wi-Fi, Bluetooth and the like, or any other proprietary protocols. Operations of touch screen control device 116 will be described in further detail below.

In the example of FIG. 1, the system 100 also includes a back end server 118 and a usage database 120. The back end server 118 includes a personalization engine that analyzes the usage habits of a user and makes recommendations based on those usage habits. The usage database 120 is where the usage habits for a user are stored. In some cases, the usage database 120 may be part of the back end server 118a. In the present example, the back end server 118 (as well as the usage database 120) is connected to the system the system 100 and accessed through the delivery network 2 (112).

Turning now to FIG. 2, a block diagram of an embodiment of a receiving device 200 is shown. Receiving device 200 may operate similar to the receiving device described in FIG. 1 and may be included as part of a gateway device, modem, set top box, or other similar communications device. The device 200 shown may also be incorporated into other systems including an audio device or a display device. In either case, several components necessary for complete operation of the system are not shown in the interest of conciseness, as they are well known to those skilled in the art.

In the device 200 shown in FIG. 2, the content is received by an input signal receiver 202. The input signal receiver 202 may be one of several known receiver circuits used for receiving, demodulation, and decoding signals provided over one of the several possible networks including over the air, cable, satellite, Ethernet, fiber and phone line networks. The desired input signal may be selected and retrieved by the input signal receiver 202 based on user input provided through a control interface 222. Control interface 222 may include an interface for a touch screen device. Touch panel interface 222 may also be adapted to interface to a cellular phone, a tablet, a mouse, a high end remote or the like.

The decoded output signal is provided to an input stream processor 204. The input stream processor 204 performs the final signal selection and processing, and includes separation of video content from audio content for the content stream. The audio content is provided to an audio processor 206 for conversion from the received format, such as compressed digital signal, to an analog waveform signal. The analog waveform signal is provided to an audio interface 208 and further to the display device or audio amplifier. Alternatively, the audio interface 208 may provide a digital signal to an audio output device or display device using a High-Definition Multimedia Interface (HDMI) cable or alternate audio interface such as via a Sony/Philips Digital Interconnect Format (SPDIF). The audio interface may also include amplifiers for driving one more sets of speakers. The audio processor 206 also performs any necessary conversion for the storage of the audio signals.

The video output from the input stream processor 204 is provided to a video processor 210. The video signal may be one of several formats. The video processor 210 provides, as necessary a conversion of the video content, based on the input signal format. The video processor 210 also performs any necessary conversion for the storage of the video signals.

A storage device 212 stores audio and video content received at the input. The storage device 212 allows later retrieval and playback of the content under the control of a controller 214 and also based on commands, e.g., navigation instructions such as fast-forward (FF) and rewind (Rew), received from a user interface 216 and/or control interface 222. The storage device 212 may be a hard disk drive, one or more large capacity integrated electronic memories, such as static RAM (SRAM), or dynamic RAM (DRAM), or may be an interchangeable optical disk storage system such as a compact disk (CD) drive or digital video disk (DVD) drive.

The converted video signal, from the video processor 210, either originating from the input or from the storage device 212, is provided to the display interface 218. The display interface 218 further provides the display signal to a display device of the type described above. The display interface 218 may be an analog signal interface such as red-green-blue (RGB) or may be a digital interface such as HDMI. It is to be appreciated that the display interface 218 will generate the various screens for presenting the search results in a three dimensional gird as will be described in more detail below.

The controller 214 is interconnected via a bus to several of the components of the device 200, including the input stream processor 202, audio processor 206, video processor 210, storage device 212, and a user interface 216. The controller 214 manages the conversion process for converting the input stream signal into a signal for storage on the storage device or for display. The controller 214 also manages the retrieval and playback of stored content. Furthermore, as will be described below, the controller 214 performs searching of content and the creation and adjusting of the gird display representing the content, either stored or to be delivered via the delivery networks, described above.

The controller 214 is further coupled to control memory 220 (e.g., volatile or non-volatile memory, including RAM, SRAM, DRAM, ROM, programmable ROM (PROM), flash memory, electronically programmable ROM (EPROM), electronically erasable programmable ROM (EEPROM), etc.) for storing information and instruction code for controller 214. Control memory 220 may store instructions for controller 214. Control memory may also store a database of elements, such as graphic elements containing content. The database may be stored as a pattern of graphic elements. Alternatively, the memory may store the graphic elements in identified or grouped memory locations and use an access or location table to identify the memory locations for the various portions of information related to the graphic elements. Additional details related to the storage of the graphic elements will be described below. Further, the implementation of the control memory 220 may include several possible embodiments, such as a single memory device or, alternatively, more than one memory circuit communicatively connected or coupled together to form a shared or common memory. Still further, the memory may be included with other circuitry, such as portions of bus communications circuitry, in a larger circuit.

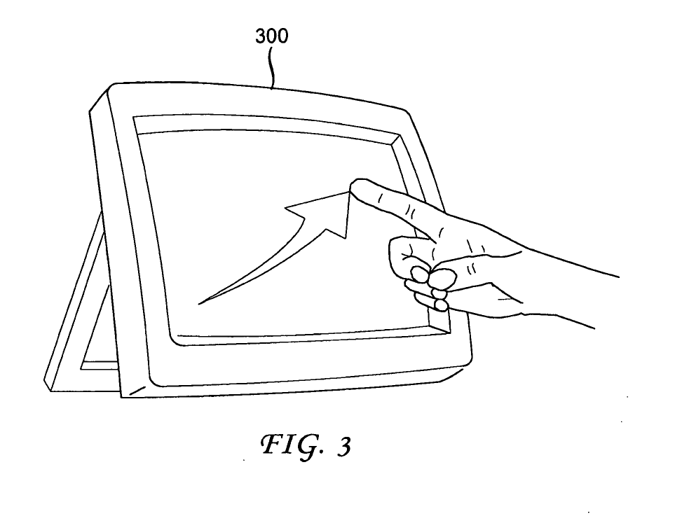

The user interface process of the present disclosure employs an input device that can be used to express functions, such as fast forward, rewind, etc. To allow for this, a second screen control device such as a touch panel device 300 may be interfaced via the user interface 216 and/or control interface 222 of the receiving device 200, as shown in FIG. 3. The touch panel device 300 allows operation of the receiving device or set top box based on hand movements, or gestures, and actions translated through the panel into commands for the set top box or other control device. In one embodiment, the touch panel 300 may simply serve as a navigational tool to navigate the grid display. In other embodiments, the touch panel 300 will additionally serve as the display device allowing the user to more directly interact with the navigation through the grid display of content. The touch panel device may be included as part of a remote control device containing more conventional control functions such as activator buttons. The touch panel 300 can also include at least one camera element.

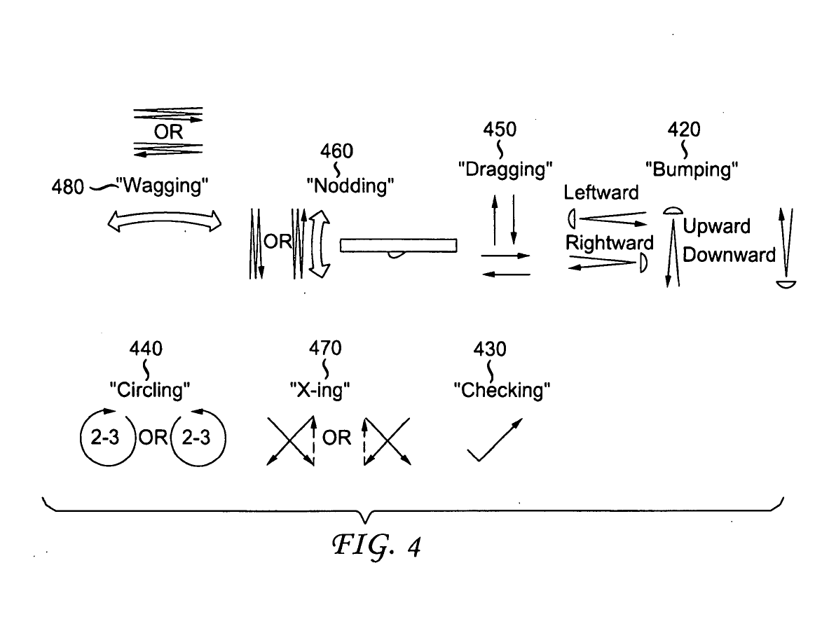

Turning now to FIG. 4, the use of a gesture sensing controller or touch screen, such as shown, provides for a number of types of user interaction or events. The inputs from the controller are used to define gestures and the gestures, in turn, define specific contextual commands or events. The configuration of the sensors may permit defining movement of a user's fingers on a touch screen or may even permit defining the movement of the controller itself in either one dimension or two dimensions. 2-dimensional motion, such as a diagonal, and a combination of yaw, pitch and roll can be used to define any 4-dimensional motion, such as a swing. A number of gestures are illustrated in FIG. 4. Gestures are interpreted in context and are identified by defined movements made by the user.

Bumping 420 is defined by a two-stroke drawing indicating pointing in one direction, either up, down, left or right. The bumping gesture is associated with specific commands in context. For example, in a TimeShifting mode, a left-bump gesture 420 indicates rewinding, and a right-bump gesture indicates fast-forwarding. In other contexts, a bump gesture 420 is interpreted to increment a particular value in the direction designated by the bump. Checking 440 is defined as in drawing a checkmark. It is similar to a downward bump gesture 420. Checking is identified in context to designate a reminder, user tag or to select an item or element. Circling 440 is defined as drawing a circle in either direction. It is possible that both directions could be distinguished. However, to avoid confusion, a circle is identified as a single command regardless of direction. Dragging 450 is defined as an angular movement of the controller (a change in pitch and/or yaw) while pressing a button (virtual or physical) on the tablet 300 (i.e., a “trigger drag”). The dragging gesture 450 may be used for navigation, speed, distance, time-shifting, rewinding, and forwarding. Dragging 450 can be used to move a cursor, a virtual cursor, or a change of state, such as highlighting outlining or selecting on the display. Dragging 450 can be in any direction and is generally used to navigate in two dimensions. However, in certain interfaces, it is preferred to modify the response to the dragging command. For example, in some interfaces, operation in one dimension or direction is favored with respect to other dimensions or directions depending upon the position of the virtual cursor or the direction of movement. Nodding 460 is defined by two fast trigger-drag up-and-down vertical movements. Nodding 460 is used to indicate “Yes” or “Accept.” X-ing 470 is defined as in drawing the letter “X.” X-ing 470 is used for “Delete” or “Block” commands. Wagging 480 is defined by two trigger-drag fast back-and-forth horizontal movements. The wagging gesture 480 is used to indicate “No” or “Cancel.”

Depending on the complexity of the sensor system, only simple one dimensional motions or gestures may be allowed. For instance, a simple right or left movement on the sensor as shown here may produce a fast forward or rewind function. In addition, multiple sensors could be included and placed at different locations on the touch screen. For instance, a horizontal sensor for left right movement may be placed in one spot and used for volume u/down, while a vertical sensor for up down movement may be place in a different spot and used for channel up/down. In this way specific gesture mappings may be used.

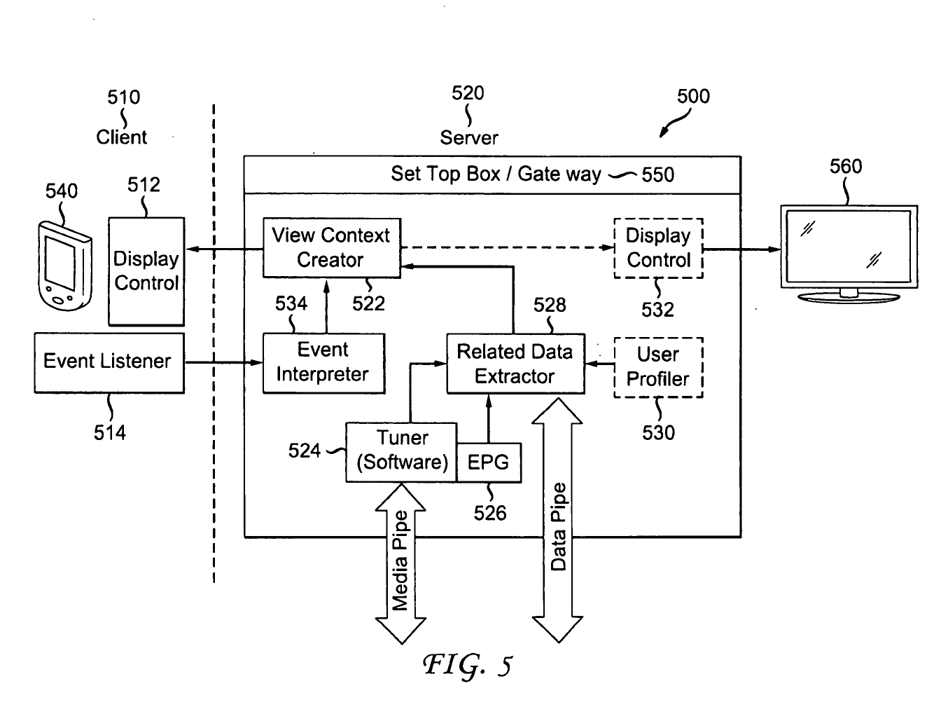

In one embodiment, the system is a receiving device 108 based software system. The system primarily makes use of the electronic program guide provided by the service provider (e.g. Comcast, Verizon, etc.) to retrieve related information of the program. In an Internet enabled receiving device 108 the system can also query different web services to get additional information about the program. The major components of the system are shown in FIG. 5.

In the currently available receiving devices 108 the user interface is configured statically. In other words the user interface is prebuilt and it gets activated on remote control key press. For example if the user is watching a sports program, regardless of whether multiple angles of the event is available or not the interface by which the user selects the program will be same. The user options will explode with availability of content from the cloud services (internet). In which case a statically pre built interface will make the navigation and selection more complex.

The software system 500 as shown in FIG. 5 has client side 510 and server side 520. The client side 510 components will reside in the second screen control device 540 either as a stand-alone application or as an installed plug-in or hidden applet in the browser. The server side 520 components reside in the receiving device (such as set top box or gateway 550) as service/daemon process. The functional modules are explained below.

### View Context Creation & Display Control

The view context creator 522 is the central piece of the system. The basic idea behind the functionality of the system is creation of user interface components according to the view context. The view context may depend upon several things like currently displayed program or content, user's personal preference, or device used as second screen control device. The tuner component 524 of the system will provide the channel identification or program identification of the event that set top box or gateway device 550 is currently tuned to. The EPG component 526 will provide the program guide information available for that particular program. The related data extractor component 528 will parse the EPG information further and produce context information for the currently consumed program. This component can optionally contact several cloud services through the data pipe (internet) and extract more context information. A user profiler 530 which provides user data can also be used by this component to enrich the context information further.

In one embodiment, the view context represents a smaller iconic view of the primary screen content enhanced with back ground information and navigational controls. For example the view context of live sports events could contain a down scaled smaller view port of the live video plus iconic representation of other available view angles of the event. The view context created by the set top box 550 will get sent over to the display control module 512 in the second screen control device 540. Display control module 512 takes care of the rendering of the view context. The display module 512 will adapt the rendering according to the device specifics. By having this module, multiple devices varying in display size and capabilities could be used as the second screen control device 540. The set top box/gate way 550 can also have a default display controller 532 which takes care of rendering the view context on the primary display screen 560 such as a television in case a rudimentary remote control without display can be used.

### Event Listener & Event Interpreter

The second part of the system is the event module. This also has client side 510 and server side 520 components. The client side 510 component is an event listener 514 running on the second screen control device 540 to capture the event happening on the device 540 and transfer the event data to the event interpreter 534 running in the set top box 550. The event data includes all peripheral user events plus associated data. This includes events raised through touch screen, accelerometer, compass and proximity sensor etc. For example single touch, multi touch, scroll, tilt, spin and proximity.

As shown in FIG. 5, event interpreter 534 gets both current view context and client side event data. The function of the event interpreter 534 is the interpretation of the event according to the current event and view context. The interpretation of event could also incur changes in view context as a result.

The functionality of the system is detailed with example scenarios in the following section. These example scenarios explain how the view context or the user interface could be different according to the context of the program.

### Scenario—1

Suppose the user is watching a wild life documentary. The system can collect the following information:
EPG module→Genre of the program
   →Start and end time of the program.
   →Availability of HD version of the program
User Profiler→A previous episode is missed and recorded in DVR
Related Data Extractor→Geographical information and images related to the current program.
View Context→Smaller view port of video
   →Iconic view (e.g. Box Art) of previous missed episode
   →Iconic view of HD version
   →A ticker of related images arid informative texts
   →RSS feeds or links to associated screen savers

### Scenario—2 (Food Channel)

View Context→Print icon to print the recipe
   →Link to online shopping web site to order stuffs
   →Ticker interface to provide related health information
   →Email icon or Share icon to share recipe with friends

### Scenario—3 (Online Collaborative Event)

Consider television programs of the sort of discussion forums or competition events where the viewers also get participated.
View Context→Interface to make voice call to the event
   →Interface to make SMS voting to the event
   →Interface to type in and send comment/greetings.
   →Interface to chat with friends
   →Interface to face book, twitter

### Scenario—4 (Live Sports Event)

View Context→Interface for collaborating with friends
   →Interface for online betting →Iconic representation of multiple angles of the event →Iconic view of replay video →Ticker interface for player updates

Once the view context is created, it is passed to the display control module 512. The view context information will be used by display controller 512 to form the user interface. The display controller 512 is a functional module in the second screen control device 540 which adapts the user interface according to the capability of the device. Set top box/gate way 550 can also have a default display controller 532 which will provide the user interface displayed on the television or primary display screen 560. The seconds screen control device 540 should also have an Event Listener component 514 which captures the event and send it back to the event interpreter 534 in the set top box 550. The event interpreter 534 in the set top box 550 executes the event in the current view context and updates the display.

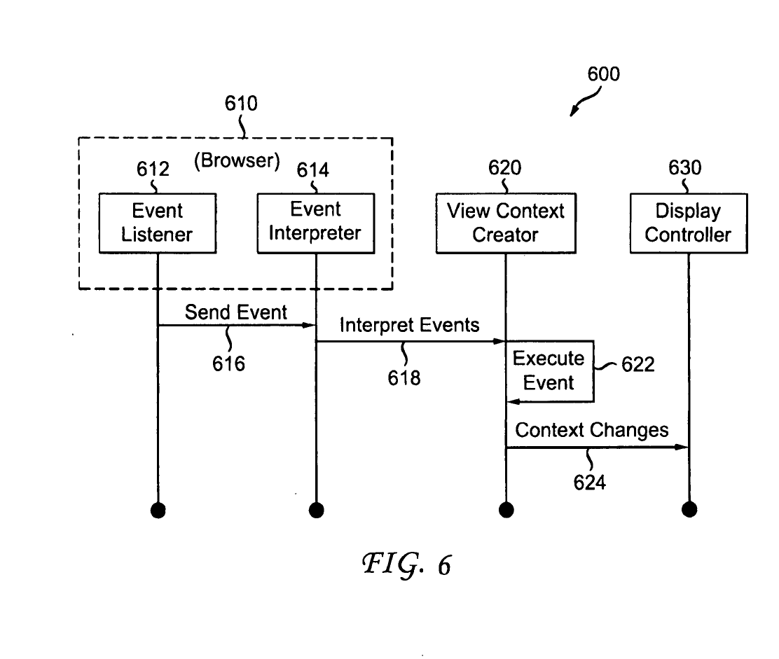

The view context can be represented using HTML/XML or any other compatible format can be used. If the view context gets converted to HTML a browser can be used as an event listener and event interpreter. An example of this can be seen in FIG. 6.

FIG. 6 shows the event execution flow using a browser. In this example, a browser 610 is used to provide the functionality of the event listener 612 and event interpreter 614 in the system 600. The system 600 also includes a view context creator 620 and display controller 630. The event listener 612 captures commands by a user or other events on the second screen control device (e.g. the selection of a button of hyperlink by the user). The event is then sent to the event interpreter 614 (as indicated by arrow 616). The event interpreter 614 provides an interpretation in view of the captured event and the current view context. The interpreted event is then provided to the view context creator 620 (as indicated by arrow 618) and executed by the system (as indicated by arrow 622). The context creator 620 updates the view context in light of the executed event and provided changes to the display controller 630 (as indicated by arrow 624).

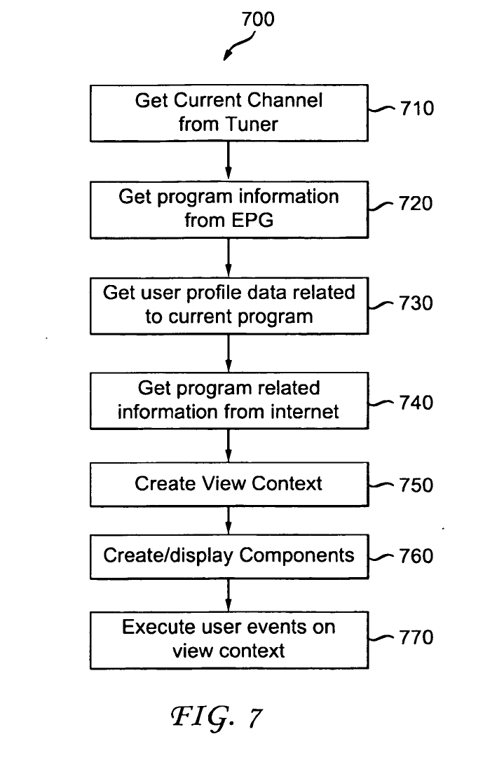

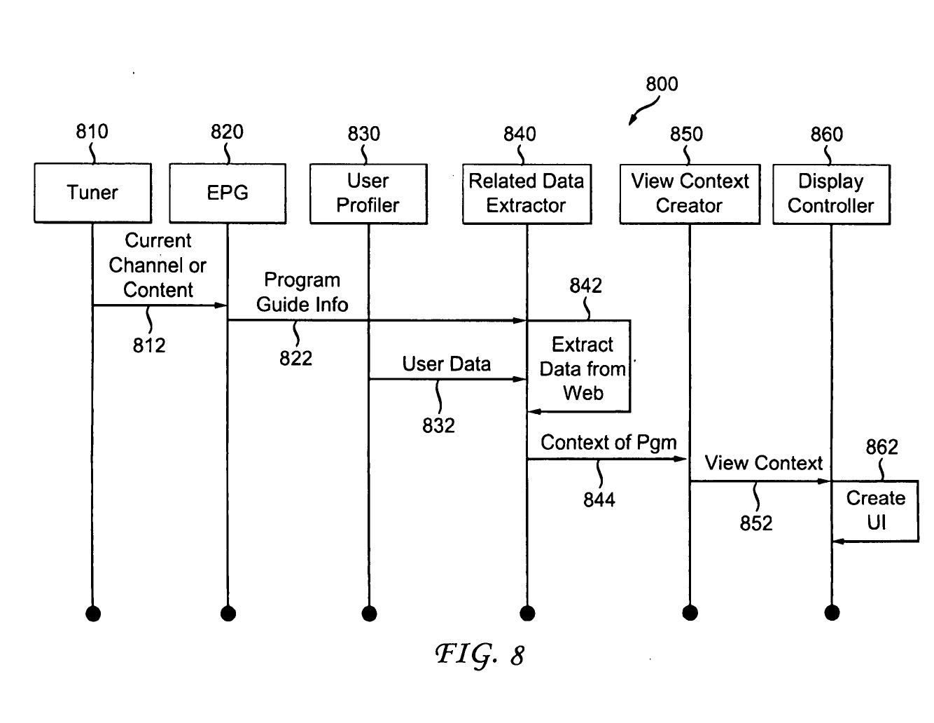

FIG. 7 depict the methodology 700 of the overall process in the system. In this example, the method 700 includes the steps of obtaining the current channel from the tuner (step 710) and obtaining the program information from the electronic program guide (EPG) (step 720). The method also includes the steps of obtaining user profile data regarding the content being displayed (step 730) and obtaining content related information from the internet (step 740). This information is then used to generate a view context (step 750). The view context can then be used to generate the components that make up a display user interface (step 760). Finally, the view context can be updated based on any detected and interpreted events (step 770). Each of these steps will be discussed in more detail below in regard to FIG. 8.

FIG. 8 shows the procedure sequence of the view context creation in the system 800. In this example the current channel or content being displayed on the primary display device is obtained from the tuner 810 (step 710). The current channel or content is provided to an electronic program guide (EPG) 820 as indicated by arrow 812. The EPG 820 is then used to obtain program information for the obtained channel or content (step 720). These steps make up the process of monitoring the content being displayed on the primary viewing screen. Conversely, if the content being displayed is a movie, such as on-demand or other streaming the title and other related data that would be found in the EPG may be provided as part of the on-demand or streaming service.

In the examples of FIG. 8, a user profiler 830 that tracks the user's viewing habits, is used to obtain user data related to the content being displayed (step 730). In other embodiments, data about the user viewing habit may be collected and collated remotely and the user profiler 830 just provides the data of the remotely constructed user profile. This user data as well as the content info obtained from the EPG 820 is provided to a related data extractor 840 as indicated by arrows 832 and 822 respectively.

The related data extractor 840 obtains the program guide info and user data as well as addition data related to the content from the Internet (step 740) as indicated by arrow 842. All this data is then used by the related data extractor 840 to create context for the content being displayed which is provided to the view context creator 850 as indicated by arrow 844.

The view context creator 850 generates a view context (step 760) as well as any updates to the view context necessitated by detected and interpreted events (step 770). The view context is provided to the display controller 860 as indicated by arrow 852. The display controller 860 uses the view context to generate the displayed user interface as indicated by arrow 862.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method for providing a dynamic user interface on a second screen control device to control content on a primary display screen, the method comprising:
monitoring content being displayed on the primary display screen;
obtaining additional information about the content being displayed on primary screen;
generating a view context based on the content being monitored, additional information, and functionality of the second screen control device; and
providing the view context to the second screen control device.

2. The method of claim 1, wherein the step of monitoring the content being displayed on the primary display screen comprises:
obtaining a current channel being displayed; and
obtaining program information for the current channel being displayed.

3. The method of claim 2, wherein the current channel being displayed is obtained from a tuner.

4. The method of claim 2, wherein the program information for the current channel being displayed is obtained from an electronic program guide.

5. The method of claim 1, wherein the step of obtaining additional information about the content being displayed is performed by a related data extractor.

6. The method of claim 1, wherein the step of obtaining additional information about the content being displayed comprises:
obtaining user profile data; and
obtaining content related information from the internet.

7. The method of claim 6, wherein the user profile data is obtained from a user profiler.

8. The method of claim 1, wherein the steps of generating a view context based on the content being monitored, additional information, and functionality of the touch screen control device; and providing the view context to the second screen control device is performed by a view context creator.

9. The method of claim 1, further comprising:
generating a user interface display on the second screen control device based on the view context.

10. The method of claim 9, wherein the step of generating a user interface display on the second screen control device based on the view context is performed by a display controller.

11. The method of claim 1, further comprising:
receiving user a command from the second screen control device; and
performing the command.

12. The method of claim 11, wherein the step of receiving a user command comprises the steps of:
detecting an event; and
interpreting the event.

13. The method of claim 12, wherein the step of detecting of an event is performed by and event listener.

14. The method of claim 12, wherein the step of interpreting of an event is performed by and event interpreter.

15. A system for controlling content on a primary display screen using a dynamically created user interface on a second screen control device, the system comprising:
a client comprising:
a first display control for controlling a display of the second screen control device; and
an event listener for receiving commands from a user on the second screen control device; and
a server in communication with the client, the server comprising:
a view context creator for generating a view context based on the content being displayed on the primary display screen, additional information, and functionality of the second screen control device; and
an event interpreter for receiving the commands from the user provided by the event listener and interpreting the commands in view of the view context generated by the view context creator.

16. The system of claim 15, wherein the server further comprises:
a related data extractor for extracting additional data related to the content being displayed on the primary display device.

17. The system of claim 16, wherein the server further comprises:
a tuner in communication with the related data extractor; and
an electronic program guide in communication with the tuner and the related data extractor.

18. The system of claim 16 wherein the server further comprises a user profiler in communication with the related data extractor for providing user profile data.

19. The system of claim 15 wherein the server further comprises a second display controller in communication with the view context creator for controlling the display of the primary display screen.

20. A computer program product comprising a computer useable medium having a computer readable program, wherein the computer readable program when executed on a computer causes the computer to perform method steps for providing a dynamic user interface on a second screen control device to control content on a primary display screen; including:
monitoring the content being displayed on the primary display screen;
obtaining additional information about content being displayed on primary screen;
generating a user interface for the second screen control device based on the content being monitored, additional information, and functionality of the second screen control device; and
displaying the user interface on the second screen control device.
